(19) United States
(12) Patent Application Publication
(10) Pub. No.: US 2003/0095850 A1
(43) Pub. Date: May 22, 2003

(54) Screw shaft and method of manufacturing the same

(75) Inventors: Kiyoshi Nishimura, Nagano (JP); Yoshiaki Koshida, Nagano (JP); Toshimi Suzuki, Nagano (JP)

Correspondence Address: HOGAN & HARTSON L.L.P., 500 S. GRAND AVENUE, SUITE 1900, LOS ANGELES, CA, 90071-2611, US

(73) Assignee: Sankyo Seiki Manufacturing Company, Ltd.

(21) Appl. No.: 10/298,410

(22) Filed: Nov. 18, 2002

(30) Foreign Application Priority Data
Nov. 19, 2001 (JP) 2001-353649

(51) Int. Cl. F16B 35/04

(52) U.S. Cl. 411/411

(57) ABSTRACT

A screw shaft including a shaft base member having a hollow part at a shaft cantor part and an outer periphery part formed with a screw part. The hollow part is formed protruded to an inner side corresponding to recessed portions of the screw part.

### BACKGROUND OF THE INVENTION

1. Field of the Invention

The present invention relates to a screw shaft and a method of manufacturing the same. More particularly, the present invention relates to a rotation shaft that is provided with a screw part on the outer periphery of a shaft and a manufacturing method thereof.

2. Description of Related Art

A rotation shaft in which a screw part is formed on the outer periphery face, such as a lead screw, has been broadly used in various devices. When such a rotation shaft as a lead screw is manufactured, a round bar material 2 is inserted between a pair of dies 1 and moved in an axial direction. The dies 1 are opposed to each other with an appropriate clearance and rotated in the opposite directions as shown in FIG. 4. A screw part is formed on the round bar material 2 by form rolling the continuous recess and projection shapes of the screw forming part 1a provided on respective dies 1 on the outer periphery face of the round bar material 2.

However, when the screw part is formed by form rolling with such dies 1, there may encounter surplus material pushed up and gathered in a crest portion of a screw part 2a from both valley sides in an axial direction. So-called top roll parts 2b of a projected shape are formed on the outer diameter portion of the screw part 2a as shown in FIG. 5. Such top roll parts 2b where an extra groove is formed on a crest portion of the screw part may cause a problem during a meshing state of the screw part. Therefore, it has been conventionally performed that the top roll parts 2b are removed from the outer periphery portion of the screw part 2a by applying a grinding process. However, an edge may be formed on the screw part 2a due to performing the grinding process to the screw part 2a. In this case, it is further necessary to perform a surface treatment such as barrel processing to make the outer periphery part of the screw part 2a smooth. Accordingly, a lead screw as an end product shown in FIG. 6 is obtained through such a grinding process or a surface treatment. However, when such a grinding process or a surface treatment is applied to thc manufacturing of a screw shaft, its productivity is reduced because extra manufacturing steps are needed.

On the other hand, in order to form a screw part having no top roll parts, one option is that a sufficient amount of the material to be formed is fed into the inside of the dies. The recess and projection shaped parts of the dies would be substantially filled with the forming material. However, in this case, too much filling may cause the dies damage or burst, or may result in the variation of the diameter of the screw part. In addition, when a curve shaped portion is required to be provided on the crest portion of the screw part 2a, it is necessary to perform a surface treatment such as the above-mentioned barrel processing.

### SUMMARY OF THE INVENTION

In view of the problems described above, it is an aspect of the present invention to provide a screw shaft and its manufacturing method capable of forming a screw part smoothly while preventing the formation of the so-called top roll parts.

In order to achieve the above aspect, according to the present invention, there is provided a screw shaft including a hollow part formed at the center portion of at least the part where the screw part is formed on the shaft bass member. Therefore, when the screw part is form-rolled by a screw forming apparatus such as a die, the plastic deformation of the shaft base member can be favorably and smoothly performed owing to the, hollow part. The plastic deformation of the shaft base member is performed corresponding to the recess and projection shape of the screw form part of the screw forming apparatus. As a result, the form rolling to the shaft base member is rapidly performed with high accuracy. In addition, since the amount of plastic deformation is considerably decreased in companion with that in the conventional solid round bar material, the variation of the shape due to the spring back caused by plastic deformation is prevented and stable rotation can be attained over a long time. Furthermore, since the shaft base member is provided with the hollow part, the whole weight of the shaft is reduced and especially the initial torque at starting is reduced, and thus a smooth rotation can be attained.

The hollow part of the screw shaft can be easily formed when the shaft bass member is provided with a through-hole in its center. A preferable example of the shaft base member having a through-hole is a longitudinal pipe material, which enables to improve its productivity.

Preferably, the screw shaft is provided with an inside support member composing of a material having an easier plasticity property than the shaft base member to be filled within the hollow part. In this configuration, the plastic deformation of the shaft base member can be satisfactorily performed without buckling. In this case, when the resin material is used for the inside support member, the filling up of the inside support member to the hollow part is highly increased and the plastic deformation of the shaft base member can be surely performed.

According to the present invention, there is also provided a manufacturing method of a screw shaft including a step of preparing a hollow part at a position at least a part which is to be formed a screw part in a shaft base member before a screw part is formed on the shaft base member. Therefore, when the screw part is form-rolled on the shaft base member by a screw forming apparatus, the plastic deformation of the shaft base member can be favorably and smoothly performed corresponding to the recess/projection shape of the screw form part of the screw forming apparatus. As a result, the form rolling to the shaft base member is rapidly performed with high accuracy and a screw shaft can be easily manufactured.

Preferably, in the manufacturing method of the screw shaft, a pipe material is used for the shaft base member and the outer diameter of the pipe material is nearly equal to the inner diameter of the recessed face in the screw form part of the screw forming apparatus. Then the pipe material is form-rolled by the screw forming apparatus such as a die. According to the method, the material of the shaft base member is fully filled within the screw form part of the die and the form rolling of the screw part is performed more precisely.

Preferably, in the manufacturing method of the screw shaft, the screw part is formed to the shaft base member after an inside support member is filled within the hollow part of the shaft base member. According to this method, plastic deformation of the shaft base member is satisfactorily performed without buckling.

Preferably, in the manufacturing method of the screw shaft, a resin material is used as the inside support member. The resin material is firstly turned into a melted state and then filled into the hollow part. After the resin material is hardened, the screw part of the shaft base member is form-rolled. According to this method, the filling of the inside support member into the hollow part can be easily performed with extremely satisfactory.

### BRIEF DESCRIPTION OF THE DRAWINGS

FIG. 1 is a partially longitudinal sectional view, which shows a step of manufacturing a lead screw using a pipe material in accordance with an embodiment of the present invention.

FIG. 2 is a side view showing the lead screw formed by the manufacturing step shown in FIG. 1.

FIG. 3 is a side view showing a finished product of the lead screw performed with a finishing step from the state shown in FIG. 2.

FIG. 4 is a partially longitudinal sectional view showing a conventional manufacturing step of a lead screw using a solid round bar material.

FIG. 5 is a side view which shows the lead screw formed by the conventional manufacturing stop shown in FIG. 4.

FIG. 6 is a side view showing a finished product of the lead screw performed with a finishing step from the state shown in FIG. 5.

### DETAILED DESCRIPTION OF THE PREFERRED EMBODIMENTS

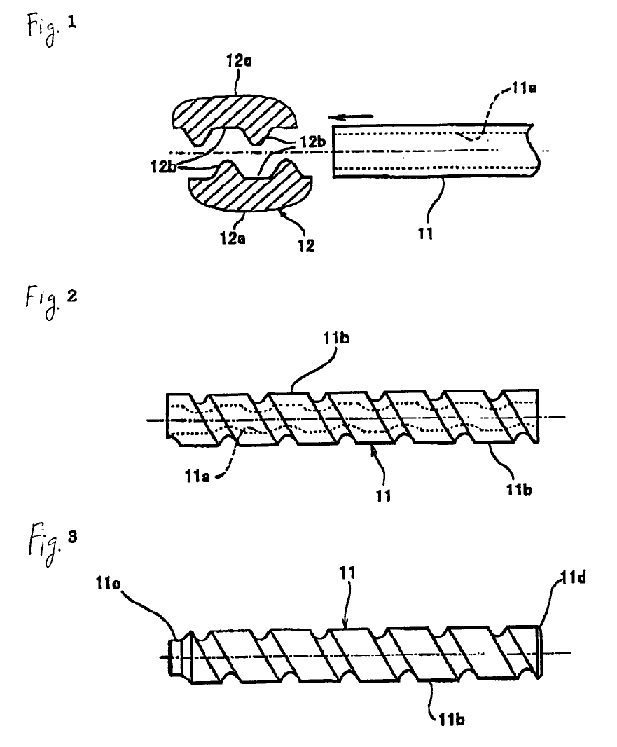

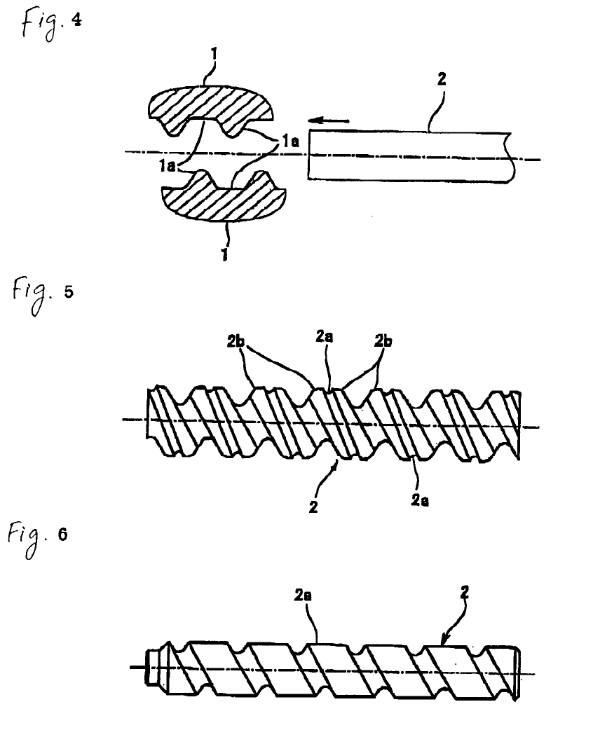

Preferred embodiments of the present invention are described below with reference to the accompanying drawings. In an embodiment shown in FIG. 1, a pipe material 11 having a through-hole 1a is used as a shaft base member which is formed into a screw shaft. The pipe material 11 is inserted into and worked by a die apparatus 12, which is a screw forming machine for manufacturing a lead screw. A pair of dies 12a are arranged so as to oppose to each other in proximity with an appropriate interval and rotated in the opposite directions. The pipe material 11 is inserted between the pair of dies 12a and the outer periphery portion of the pipe material 11 is form-rolled by the continuous recess/projection shaped portion of the screw form part 12b provided in each of the dies 12a.

The pipe material 11 as the shaft base member is provided at its center part with a through-hole 11a that is a hollow part along the axial direction. The thickness of the pipe material 11 in a radial direction is set such that the pipe material 11 can be easily form-rolled by the screw form part 12b of the dies 12a. The inner face of the pipe material 11 is deformed inside to form an inner protrusion. Therefore, when the screw part 11b is form-rolled on the outer periphery face of the pipe material 11, the pipe material 11 is smoothly deformed to the inside of the hollow part corresponding to the recess/projection shaped portion of the screw form part 121b as shown in FIG. 2. Accordingly, the form rolling operation of the screw form part 12b of the die 12a is rapidly performed with high accuracy.

In the present embodiment, since the pipe material 11 is used as a shaft base member, efficient and satisfactory productivity is attained because it is not necessary to specially form a hollow part. The outer diameter of the pipe material 11 is preferably set to be nearly equal to the inner diameter of the bottom face of the recessed part in the screw form part 12b of the die 12a. In this case, the pipe material 11 is filled up within the bottom face of the recessed part of the screw form part 12b and the form rolling of the screw part 11b is performed more precisely. The outer diameter of the pipe material 11 may be larger than the inner diameter of the bottom face of the screw form part 12b when the pipe material 11 can be inserted into the screw form part 12b of the die 12a. On the other hand, the outer diameter of the pipe material 11 can be smaller than the inner diameter of the bottom face of the screw form part 12b to an extent that the top roll part is not formed in a screw crest portion when the pipe material 11 is preformed with plastic deformation.

The tip part 11c and the rear end part 11d in an axial direction of the pipe material 11 in which the screw part 11b is formed by the die apparatus 12 are finished respectively to be an end product of the lead screw as shown in FIG. 3.

The lead screw formed of the pipe material 11 can considerably reduce the amount of plastic deformation compared to that of the conventional solid round bar material. Thus, a shape variation due to the spring back after plastic deformation is prevented over time and a stable rotation can be performed for a long period. In addition, since the lead screw is provided with the hollow part, its weight is reduced, and thus, particularly all initial torque required at starting is reduced and a smooth rotation is enabled.

In this embodiment, it is preferable that an inside support member of resin material, of which plastic deformation is easier than that of the pipe material 11 is filled within the hollow part, namely, the through-hole 11a of the pipe material 11. When the inside support member of such a plasticity is filled inside the pipe material 11, the plastic deformation of the pipe material 11 is satisfactorily performed without forming a buckle and manufacturing a lead screw is enabled further surely.

Tho inside support member is not limited to a resin material but any material can be used of which the plastic deformation is easier than that of the pipe material 11. When the resin material is used as the inside support member, it can be preferably filled into the through-hole 11a of the pipe material 11 after it has once turned into a melted state. In this case, the filling of the inside support member into the through-hole 11a of the pipe material 11 is extremely easily and satisfactorily performed. The forming step of the screw part 11b using the die apparatus 12 is performed after the filled resin material has been solidified.

Although the present invention has been shown and described with reference to specific preferred embodiments, various changes and modifications will be apparent to those skilled in the art from the teachings herein.

For example, in the above-mentioned embodiment, a longitudinal pipe material is used as a shaft base member having a hollow part, but it is sufficient that a hollow part is provided at least at a part forming a screw of a shaft base member. Therefore, a material especially formed with a partially hollow part or a material originally having a partially hollow part, which is not an ordinary longitudinal pipe member, is used as the shaft base member.

An apparatus for forming a screw part to a shaft base member is not limited to a die apparatus, various apparatuses which can perform plastic deformation to the outer peripheral part of the shaft base member can be adopted similarly.

The present invention is also applicable to other types of screw shafts different from the above mentioned embodiment.

As described above, the screw shaft according to the present invention is provided with a hollow part formed at least at a center portion of the part where a screw part is formed on the shaft base member. The screw part is form-rolled on the shaft base member by a screw forming apparatus. Therefore, the plastic deformation of the shaft base member can be favorably and smoothly performed corresponding to the recess/projection shape of the screw form part of the screw forming apparatus. As a result, the form roiling of the shaft base member is rapidly performed with high accuracy. Also, the variation of shape due to the spring back after plastic deformation is prevented and stable rotation can be performed over a long time. Furthermore, since the shaft base member is provided with the hollow part, the entire weight of the shaft is reduced and a smooth rotation can be attained.

In a manufacturing method of a screw shaft according to the present invention, there is provided a step of preparing a hollow part at a position at least a part which is to be formed a screw part in a shaft base member. After that, the screw part is form-rolled on the shaft base member by a screw forming apparatus. Plastic deformation of the shaft base member can be favorably and smoothly performed corresponding to the recess/projection shape of the screw form part of the screw forming apparatus. As a result, the form rolling to the shaft base member is rapidly performed with high accuracy and a screw shaft can be easily manufactured.

What is claimed is:

1. A screw shaft comprising:
a shaft bass member having a hollow part at a shaft center part and an outer periphery part formed with a screw peat;
wherein the hollow part is formed protruded to an inner side corresponding to recessed portions of the screw part.

2. The screw shaft according to claim 1, wherein the hollow part is a through-hole formed at the shaft center part of the shaft base member in the axial direction.

3. The screw shaft according to claim 2, wherein the shaft base member is a pipe material.

4. The screw shaft according to claim 1, wherein an inside support member of a material which has an easier plasticity than that of the shaft base member is filled in the hollow part.

5. The screw shaft according to claim 4, wherein the inside support member is a resin material.

6. The screw shaft according to claim 1, wherein the screw part is helically and continuously formed on the outer peripheral part of the shaft base member and the hollow part is also helically and continuously formed of an inner protruded portion corresponding to a bottom portion of the screw part.

7. A method of manufacturing a screw shaft, comprising:
preparing a screw forming apparatus provided with a screw form part including a recess/projection shaped part in an axial direction;
providing a shaft base member provided with a hollow part at a shaft center part and an outer periphery face
inserting the shaft base member in the screw forming apparatus; and
form-rolling the outer periphery face of the shaft base member to the hollow part by the screw form part of the screw forming apparatus to form a screw part on the outer periphery face of the shaft base member.

8. The method of manufacturing a screw shaft according to claim 7, further comprising providing a pipe material as the shaft base member and providing an outer diameter of the pipe material nearly equal to an inner diameter of a recessed bottom face of the screw form part of the screw forming apparatus.

9. The method of manufacturing a screw shaft according to claim 7, farther comprising filling the hollow part of the shaft base member with an inside support member and then forming the screw part to the shaft base member.

10. The method of manufacturing a screw shaft according to claim 9, further comprising:
providing a resin as the inside support member;
turning the resin material into a melted state and at the same time filling the resin material into the hollow part; and
after the resin material has hardened, forming the screw part on the shaft base member.

11. The screw shaft according to claim 1, wherein the screw part is free of top roll parts.

12. The screw shaft according to claim 1, wherein the screw part is form-rolled by a die.

13. The screw shaft according to claim 12, wherein the plastic deformation of the shaft base member is performed corresponding to recess and project shapes of the die.

14. Thc screw shaft according to claim 1, wherein the hollow part of the shaft prevents variations in shape due to a spring back effect caused by plastic deformation.

15. The screw shaft according to claim 14, wherein the hollow part of the shaft causes an amount of plastic deformation to decrease.

16. The method of manufacturing a screw shaft according to claim 7, further comprising causing an amount of plastic deformation to decrease.

17. The method of manufacturing a screw shaft according to claim 7, further comprising preventing top roll parts from forming on the screw part.

18. The method of manufacturing a screw shaft according to claim 7, further comprising form-rolling the screw part with a die.

19. The method of manufacturing a screw shaft according to claim 18, further comprising performing the plastic deforming of the shaft base member corresponding to recess and projection shapes of the die.

20. The method of manufacturing a screw shaft according to claim 7, further comprising preventing variations in shape due to a spring effect caused by plastic deformation.
